(19) United States
(12) Patent Application Publication
(10) Pub. No.: US 2023/0419786 A1
(43) Pub. Date: Dec. 28, 2023

(54) METHOD, APPARATUS, AND PROGRAM PRODUCT FOR TRIGGERING AND CONTROLLING JACKPOT GAMING MACHINE OPERATION

(71) Applicant: Everi Games, Inc., Austin, TX (US)

(72) Inventor: James D. Crow, Austin, TX (US)

(73) Assignee: Everi Games, Inc., Austin, TX (US)

(21) Appl. No.: 17/851,445

(22) Filed: Jun. 28, 2022

(51) Int. Cl. G07F 17/32

(52) U.S. Cl. CPC G07F 17/3267; G07F 17/3213; G07F 17/3258; G07F 17/34

(57) ABSTRACT

A display system of a gaming machine to is controlled display a symbol array including an array area a control play of a game. During the play, game symbol locations are populated in the array area selected from a game symbol set which includes at least a first trigger symbol and a second trigger symbol. Responsive to a winning condition including a predetermined positive number of trigger symbols comprising zero or more of the first trigger symbols and zero or more of the second trigger symbols, a jackpot win round is performed including (i) based on the numbers of first or second trigger symbols in the winning condition, selecting a set of the jackpot prize indicators, and (ii) randomly selecting a jackpot prize indicator from the selected set and awarding an associated jackpot prize for the play at the gaming machine.

### TECHNICAL FIELD OF THE INVENTION

The invention relates to gaming systems and methods which provide reel-type games. More particularly, the invention relates to gaming systems and methods providing jackpot prizes.

### BACKGROUND OF THE INVENTION

Mechanical and video reel-type wagering games display results for a given play in the game using an array of game symbol locations. In the course of a play in a reel-type wagering game (which may be referred to generally as a “slot game”), the various game symbols appearing at the different game symbol locations (or at least some of the different game symbol locations) are randomized or selected according a random result. The randomization or apparent randomization is performed by spinning a reel which carries on its periphery the various game symbols for the game, or, in the case of video reel-type games, by conducting a reel spin simulation for one or more simulated reels shown on a video display. A reel-type game may include physical or simulated multiple-symbol reels which each provide multiple game symbol locations in the array, or may include physical or simulated single-symbol reels which each show only a single game symbol location of the array.

Winning results may be defined for a given combination of game symbols appearing in a predefined winning game symbol location pattern commonly referred to as a “payline” defined through the array of game symbol locations. Winning results may also be defined in terms of the number of a given game symbol or different game symbols appearing in the array after randomization, commonly referred to as a “scatter pay.” The combinations of game symbols which represent a winning result along a payline or as a scatter pay are defined in a pay table which relates each such combination of game symbols to a respective prize, or multiple prizes with each prize corresponding to a bet level in effect for the play in the game. Any prizes as defined by the pay table are awarded in some fashion at the completion of a given play such as by incrementing a credit meter at the gaming machine.

Reel-type gaming machines may offer special features in addition to a primary or base game conducted at a gaming machine. Such special features are seen as a way to vary the player's gaming experience at a given gaming machine and may involve spins of the same or different physical or simulated reels defining the original game symbol location array. In view of the popularity of special features for reel-type gaming machines, there is a continuing need both for new implementations triggering and controlling added features in gaming machines.

### SUMMARY OF THE INVENTION

Aspects of the present invention include methods, apparatus, and program products for providing a jackpot set selection feature in reel-type gaming machine. Additional aspects of the present invention encompass methods, apparatus, and program products for controlling the operation of reel-type gaming machines.

In accordance with this first aspect of the invention, a method is provided for controlling a reel-type gaming machine. The method includes controlling a display system of the gaming machine to display a game symbol array for a play at the gaming machine including an array area of at least one row and at least three columns in which symbols are shown and evaluated. The display system also displays a series of jackpot prize indicators in a secondary display area. During the play at the gaming machine, the method includes populating game symbol locations in the array area selected from a game symbol set which includes at least a first trigger symbol and a second trigger symbol. Responsive to a winning condition including a predetermined positive number of trigger symbols comprising zero or more of the first trigger symbols and zero or more of the second trigger symbols, the method includes performing a jackpot win round including (i) based on the numbers of first or second trigger symbols in the winning condition, selecting a set of the jackpot prize indicators, and (ii) randomly selecting a jackpot prize indicator from the selected set and awarding an associated jackpot prize for the play at the gaming machine.

In some implementations of the first aspect, the winning condition includes the predetermined number of first or second trigger symbols disposed along a winning payline of the game symbol array. In some other implementations, the winning condition includes at least one of the first trigger symbols or the second trigger symbols in each column of the array area.

In some implementations of the first aspect, selecting a set of the jackpot prize indicators comprises displaying a starting set of jackpot prize indicators and removing one or more of the jackpot prize indicators from the starting set based on the number of first trigger symbols in the winning condition, the one or more removed jackpot prize indicators being those with the lowest value. Removing one or more of the jackpot prize indicators from the starting set may include displaying a graphic sequence in which the one or more removed jackpot prize indicator is greyed out. In some implementations, one jackpot prize indicator is removed responsive to one of the first trigger symbols appearing in the winning condition, and two jackpot prize indicators are removed responsive to two of the first trigger symbols appearing in the winning condition. In some implementations, four jackpot prize indicators are removed responsive to three of the first trigger symbols appearing in the winning condition.

A gaming machine according to a second aspect of the present invention includes a display system, a player input system, and least one processor. At least one memory device of the gaming machine stores instructions which are executable by the at least one processor to produce the array area and the expansion array area, display a game play through the gaming machine, and award prizes in accordance with the above-described method.

Because methods and gaming machines according to the present invention may be implemented with processing devices operating under the control of program code, another aspect of the present invention includes a program product comprising one or more non-transitory computer readable data storage devices storing program code. The program code is executable by one or more processors such as a gaming machine processor arrangement to perform the operations described above in connection with methods according to the invention.

These and other advantages and features of the invention will be apparent from the following description of representative embodiments, considered along with the accompanying drawings.

### BRIEF DESCRIPTION OF THE DRAWINGS

FIG. 1 is a perspective view of a gaming machine that may be used for a target interactive game in accordance with implementations of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is a process flow diagram showing a process for operating a game according to some aspects of the present invention.

FIG. 5 illustrates in diagram form a game screen of a reel-type game in accordance with aspects of the present invention

FIGS. 6-12 are a sequence of game screen diagrams representing a game over several points in time according to various aspects of the present invention.

### DESCRIPTION OF REPRESENTATIVE EMBODIMENTS

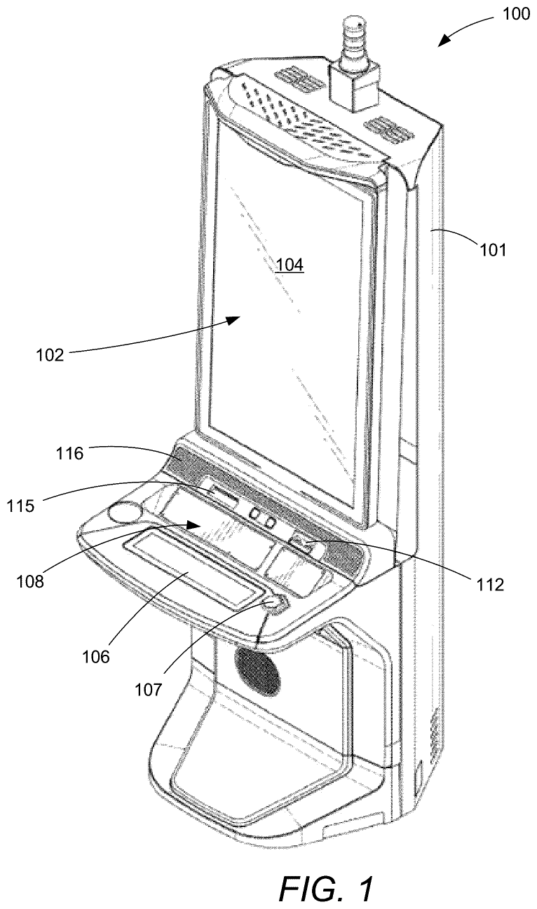

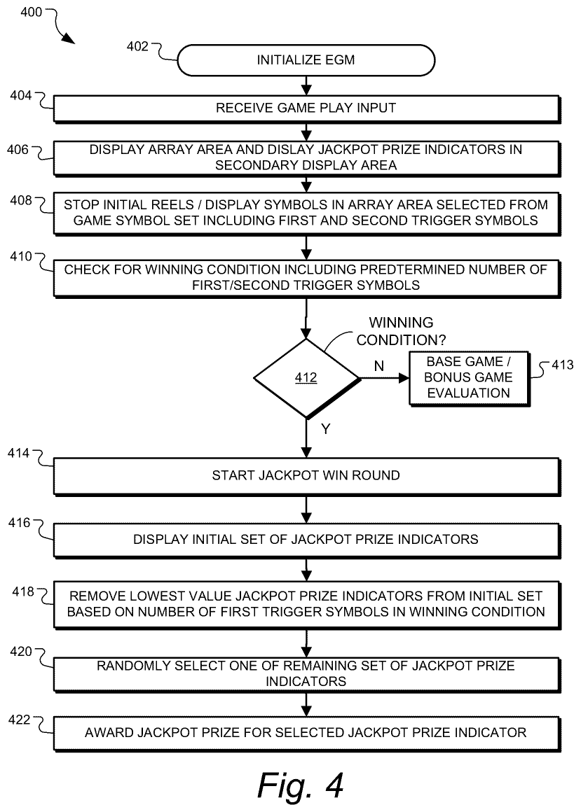

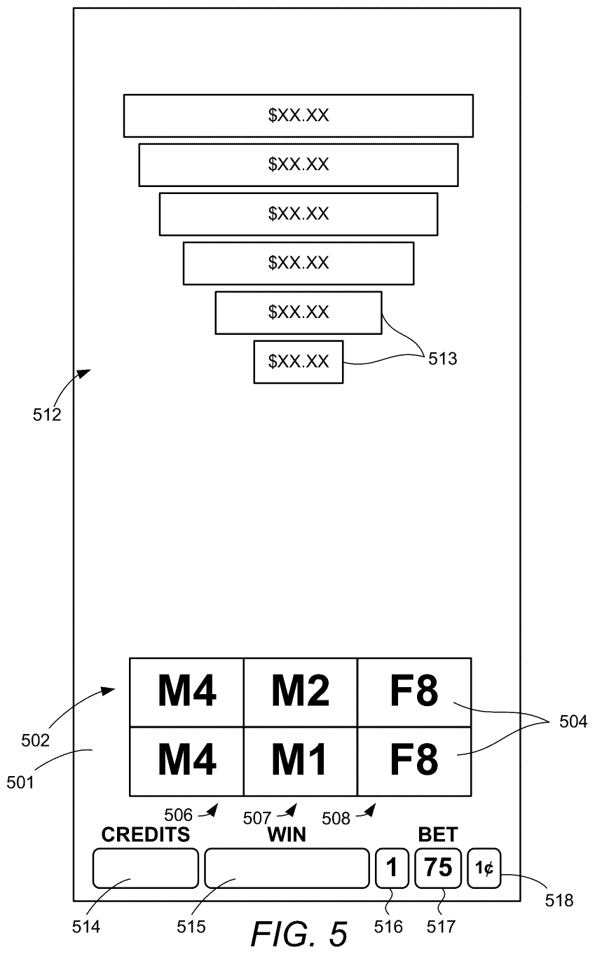

FIGS. 1-3 will be used to describe gaming machines and gaming networks in which aspects of the present invention may be implemented. FIG. 4 will be used to describe example methods of controlling a gaming machine to conduct a game according to various implementations of the present invention. FIGS. 5-12 will be referenced below to describe operation of gaming machines according to various implementations.

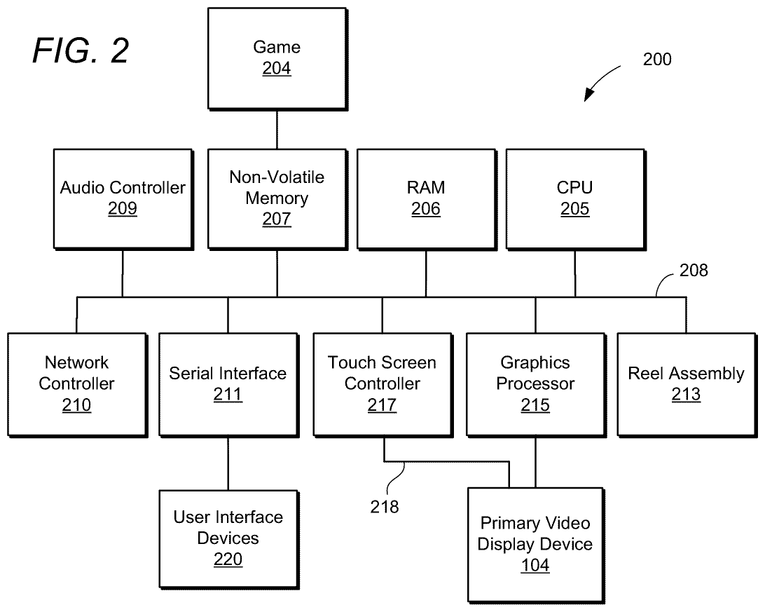

Referring to FIG. 1, gaming machine 100 includes a cabinet 101 having a front side generally shown at reference numeral 102. A primary video display device 104 is mounted in a central portion of the front side 102, and a touch-screen button panel 106 is positioned below the primary video display device. Gaming machine 100 may include additional smaller auxiliary display devices (not shown) in the area shown generally at 108. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 104, may be used to display graphics associated with a reel-type game in accordance with aspects of the present invention. As will be described further below in connection with FIG. 2 and elsewhere, it is also possible for gaming machines within the scope of the present invention to include mechanical elements such as mechanical reels. Generally, the display device or display devices of the gaming machine, through which a reel-type game may be presented may be described in this disclosure and the accompanying claims as a “display system” regardless of whether the display arrangement includes video displays showing reel simulations or physical reels, or combinations of the two.

The gaming machine 100 illustrated for purposes of example in FIG. 1 also includes a mechanical control button 107 mounted adjacent to touch-screen button panel 106. This control button 107 may allow a player to make a play input to start a play in a wagering game conducted through gaming machine 100, while virtual buttons included (but not shown in this view) on button panel 106 or other physical buttons or controls (not shown) may allow a player to select a bet level for a game implemented at the gaming machine and select a type of game or game feature. Touch-screen button panel 106 may also be used in implementations of reel-type games encompassing aspects of the invention to allow the player to control a cursor that may be displayed on another display device. Other forms of gaming machines through which the invention may be implemented may include switches, joysticks, or other mechanical input devices, in addition to the virtual buttons and other controls implemented on touch-screen button panel 106. For example, primary video display device 104 in gaming machine 100 provides a convenient display device for implementing touch screen controls in addition to or in lieu of controls included on touch-screen button panel 106 or mechanical controls. The player interface devices which receive player inputs in the course of a game played through the gaming machine, such as controls to select a wager amount for a given play, controls to enter a play input to actually start a given play in the wagering game, or controls to allow a player to make other player inputs in a game according to the present invention, may be referred to generally as a “player input system.”

It will be appreciated that gaming machines may also include a number of other player interface devices in addition to devices that are considered player controls for use in entering inputs in the course of a particular game. Gaming machine 100 also includes a currency/voucher acceptor having an input ramp 112, a voucher/receipt printer having a voucher/receipt output 115, and a player card reader (not shown in the view of FIG. 1). Numerous other types of player interface devices may be included in gaming machines that may be used to implement embodiments of the present invention.

Gaming machine 100 may also include a sound system to provide an audio output to enhance the user's playing experience. For example, illustrated gaming machine 100 includes speakers behind grille 116 which may be driven by a suitable audio amplifier (not shown) to provide a desired audio output at the gaming machine.

FIG. 2 shows a logical and hardware block diagram 200 of gaming machine 100 which includes a processor (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 (the display device 104 being mounted on cabinet 101 as shown in FIG. 1). As shown in FIG. 2, gaming machine 100 also includes a touch screen controller 217 connected to system bus 208. Touch screen controller 217 is also connected via signal path 218 to receive signals from a touch screen element associated with primary video display device 104 or touch-screen button panel 106 or both. It will be appreciated that the touch screen element itself typically comprises a thin film that is secured over the display surface of the respective display device such as the display device of touch-screen button panel 106 in FIG. 1. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured for use in a wagering game environment. These elements may be mounted on (or connected to) a standard personal computer motherboard and housed in a standard personal computer housing which itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller for example. It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention. For example, a gaming machine in some embodiments of the present invention may rely on one or more data processors which are located remotely from the gaming machine itself. Embodiments of the present invention may include no processor such as CPU 205 or graphics processor such as 215 at the gaming machine, and may instead rely on one or more remote processors. Thus unless specifically stated otherwise, the designation “gaming machine” is used in this disclosure and the accompanying claims to designate a system of devices which operate together to provide the indicated functions. A “gaming machine” may include a gaming machine such as gaming machine 100 shown in FIGS. 1 and 2, which is itself a system of various components, and may also include one or more components remote from a gaming machine cabinet (that is, cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as identifying prizes for a given play and controlling reel spin simulations, and performing other operations described below in the examples of FIGS. 4A and 4B.

It will also be appreciated that graphics processors are also commonly a part of modern computer systems. Although separate graphics processor 215 is shown for controlling primary video display device 104, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display devices or other types of display devices. While the large display device 104 is particularly suited for showing additional groups of game symbol locations in accordance with some implementations of reel-type games in accordance with aspects of the present invention, the display area may be arranged differently than the portrait orientation shown or divided across multiple discrete display devices within the scope of the present invention.

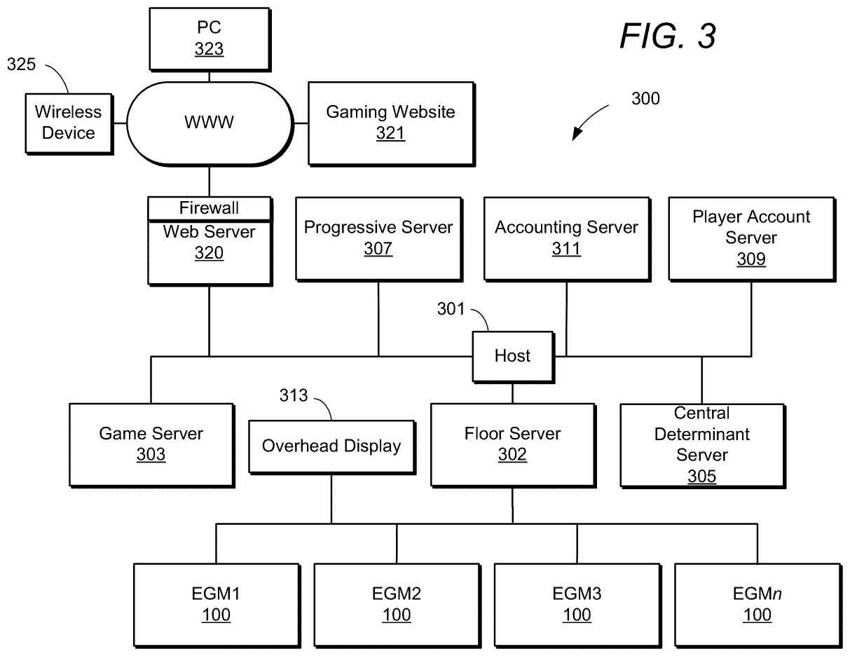

In the illustrated gaming machine 100, CPU 205 executes software, that is, program code, which ultimately controls the entire gaming machine including the receipt of player inputs and the presentation of the graphics or information displayed according to the invention through the display devices 104 and 106 associated with the gaming machine. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software (program code) prior to loading into random access memory 206 for execution, or for programs not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, which may comprise an Intel® or AMD® processor for example, these special purpose processing devices may not employ operational program code to direct the various processing steps.

The example gaming machine 100 is shown in FIG. 2 as including user interface devices 220 (part of a player input system) connected to serial interface 211. These user interface devices may include various player input devices such as mechanical buttons, virtual buttons shown on touch-screen button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine which may present reel-type games in accordance with aspects of the present invention may also include mechanical reels. For example, a number of sets of mechanical reels may replace the primary display device 104, or at least part of that display device. Alternatively, mechanical reels may be included in the gaming machine behind a light-transmissive video display panel. Mechanical reels may also include one or more video display devices in place of a static reel symbol strip and thus be capable of conducting single-symbol reel spin simulations for one or more game symbol locations. In any case, the mechanical reels represent a display device for displaying various game symbols in the course of a game play. Although the invention is not limited to any particular mechanical reel arrangement or control system, mechanical reels may be controlled conveniently through serial communications which provide instructions for a respective stepper motor for each reel. Thus some embodiments of the present invention which employ mechanical reels may use a serial interface device such as serial interface 211 to control communications with the reel assembly, and may not include a direct bus interconnection as indicated by FIG. 2. Details of a mechanical reel arrangement and various accent lighting arrangements which may be associated with mechanical reels are not shown in the present FIG.s so as to avoid obscuring the present invention in unnecessary detail.

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead displays 313 may be operatively connected so that the overhead display or displays may mirror or replay the content of one or more displays of gaming machines 100. For example, the primary display content for a given gaming machine 100 (including a game play according to the present invention) may be transmitted through network controller 210 to a controller associated with the overhead display(s) 313. In the event gaming machines 100 have cameras installed, the respective player's video images may be displayed on overhead display 313 along with the content of the player's gaming machine display.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the outcome information to networked gaming machines 100 which present the games to players.

Tournament server 306 may be included in the system for controlling or coordinating tournament functions. These functions may include maintaining tournament player scores and ranking in reel time during the course of tournament play, and communicating this information to the various gaming machines 100 participating in the tournament. Tournament server 306 may also function to enroll players in tournaments, schedule tournaments, and maintain the time remaining in the various tournaments.

Progressive server 307 may maintain progressive pools for progressive games which may be available through the various gaming machines 100 (such as some prizes defined for the game described further below). In some implementations, progressive server 307 may simply receive communications indicating contribution amounts which have been determined by processes executing at the various gaming machines 100 or elsewhere in the gaming network. Alternatively, progressive server 307 may perform processes to determine the contribution amounts for incrementing the various progressive pools which may be maintained. Progressive server 307 may also periodically communicate current pool values back to the various gaming machines 100, and may participate in communicating awarded progressive prize amounts to the gaming machines and making adjustments to the progressive prize pools accordingly. In some implementations, progressive server 307 may also determine or participate in determining when a progressive prize triggering event occurs.

Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a Blackberry® cell phone, Apple® iPhone®, personal digital assistant (PDA), iPad®, etc.). To enter website 321, a player may log in with a user name that may, for example, be associated with the player's account information stored on player account server 309. Once logged in to website 321 the player may play various games on the website, including games according to the invention. Also website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network which may facilitate target interactive games according to aspects of the present invention, and is not intended to be limiting in any way. Reel-type games according to aspects of the present invention are not limited to use with gaming networks such as network 300.

FIG. 4 show a flowchart 400 of an example method of conducting game plays in a reel-type gaming machine in accordance with aspects of the present invention. The depicted process is suitable for implementation under control of a processor of a gaming machine such as processor 205 executing program code stored on a non-volatile memory such as memory device 207 (FIG. 2). The illustrated method includes initializing the EGM (such as gaming machine/EGM 100 shown in FIGS. 1 and 3) at block 402 and then receiving a game play input as shown at block 404. Initializing the gaming machine as indicated at block 402 may include, for example, receiving an input of credits for play from a player. Credits may be applied to the gaming machine through a voucher system, player account system, or any other arrangement. In any event, initializing the gaming machine places it in condition to receive game play inputs as indicated at block 404. These game play inputs may be received in any suitable fashion, such as, for example, through a player actuated control such as a “Play” button or lever. Each game play input may be associated with a wager which is selected or entered by the player through a suitable control included in the player input system.

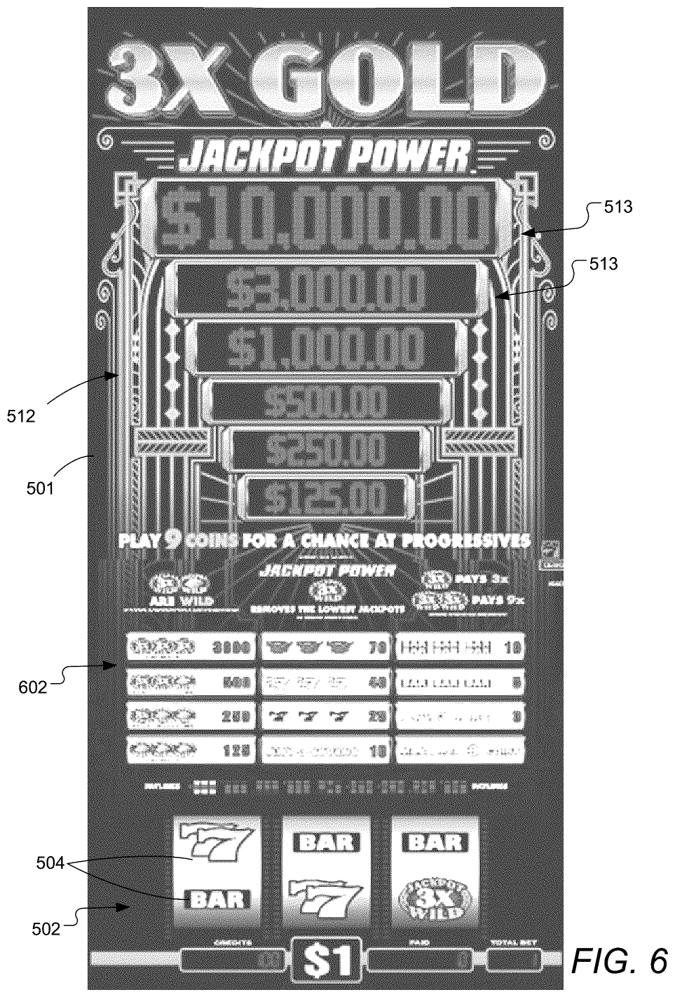

In response to the game play input, at block 406, the process includes displaying an array area including symbol locations and a secondary display area including a number of jackpot prize indicators, and populating game symbol locations at block 406. An example of an array area and secondary display area are discussed below with respect FIG. 5. In this example, the array area includes simulated reels, but in other examples the array of symbol locations may be implemented in other ways. An example of a game in process at block 406 is shown in FIG. 6, in which at array area 502 shows spinning reels.

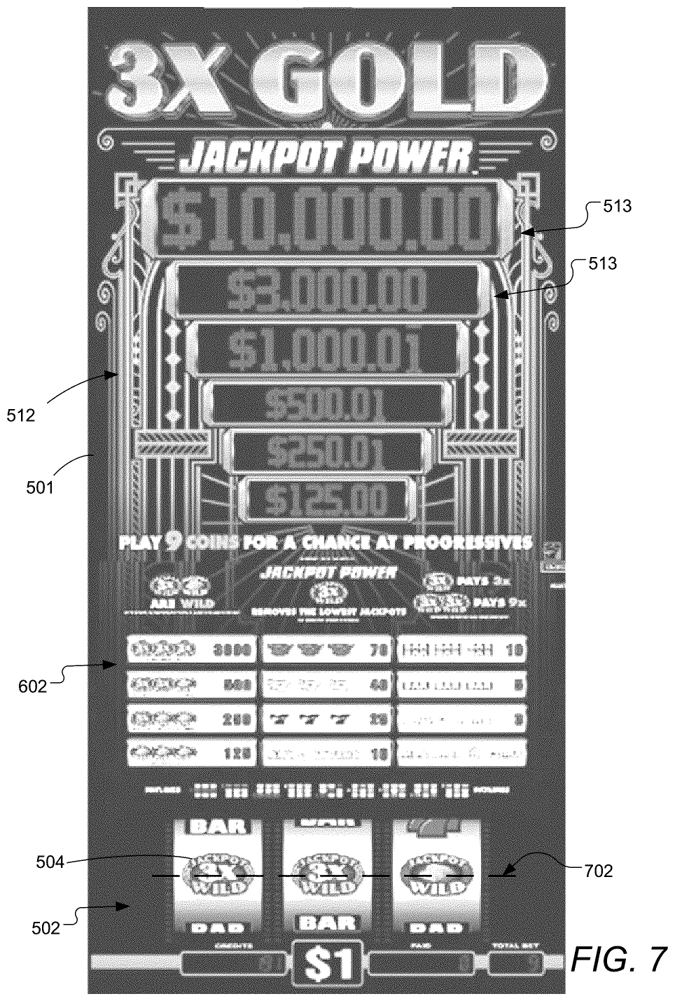

At block 408, where the process stops the set of reels, with game symbols on the reels thereby aligning with the various game symbol locations of the array area. An example of a game in process at block 408 is shown in FIG. 7, in which symbol locations on the reels are aligned along a payline 702. The game symbols are selected from a game symbol set which includes at least a first trigger symbol and a second trigger symbol. In the example of FIG. 7, the first trigger symbol is a graphic symbol 504 with graphics saying “3X JACKPOT WILD”, and the second trigger symbol is a graphic symbol 504 with graphics saying “JACKPOT WILD”.

At block 410, the process checks for a winning condition in which a predetermined positive number of trigger symbols comprising zero or more of the first trigger symbols and zero or more of the second trigger symbols are present. As can be understood, in some scenarios the winning condition may include all first trigger symbols, all second trigger symbols, or a combination of the two. In the example implementation of FIG. 7, such a condition is defined along a payline 702. In other implementations, other methods of defining the winning condition may be used, such as, for example, one of the first or second trigger symbols appearing in each reel, or appearing in a designated set of reels. Responsive to the presence of the winning condition, the process at block 412 goes to block 414. If the winning condition is not present the process at block 412 goes to block 413, where it evaluates the base game result following the rules of the base game, and may perform and evaluate other bonus features.

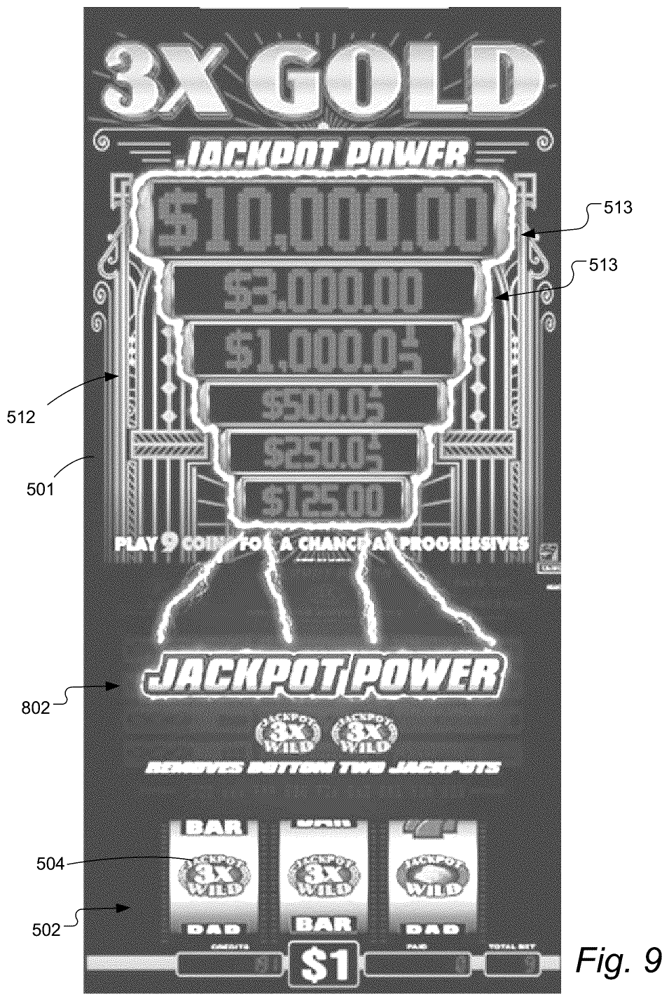

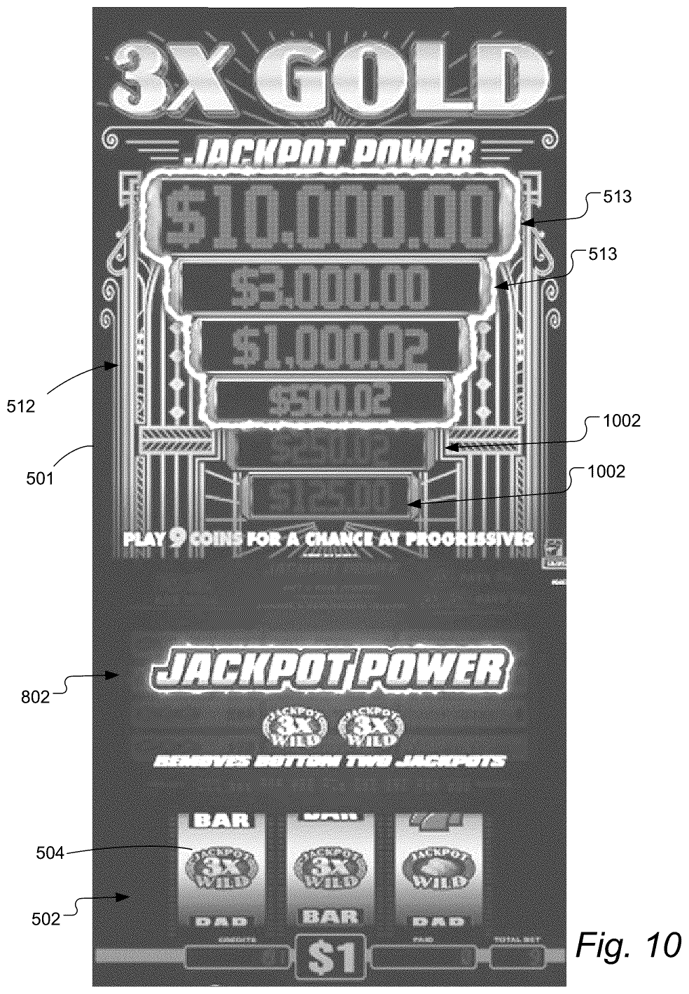

At block 414, the process starts performing a jackpot win round, which generally includes, based on the numbers of first or second trigger symbols in the winning condition, selecting a set of the jackpot prize indicators, and then randomly selecting a jackpot prize indicator from the selected set and awarding an associated jackpot prize for the play at the gaming machine. In the example implementation of FIGS. 6-12, selecting a set of jackpot prize indicators includes displaying a starting set of jackpot prize indicators (i.e. 513, FIG. 9) at block 416. Then at block 418, the process includes removing one or more of the jackpot prize indicators (i.e. 1002, FIG. 10) from the starting set based on the number of first trigger symbols in the winning condition, the one or more removed jackpot prize indicators being those with the lowest value. An example of such selection is shown in the subsequence of FIG. 9 and FIG. 10. In other implementations, other methods of selecting the set of jackpot prize indicators may be used. For example, multiple predefined sets may be provided and selected among. Such sets may include jackpots of different values from those in the other sets.

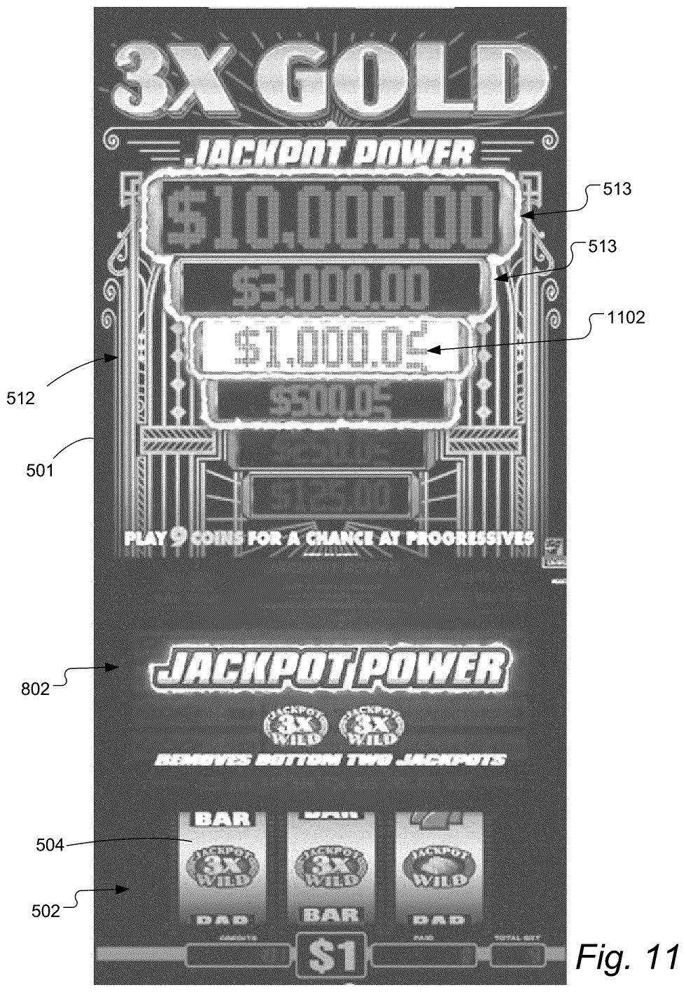

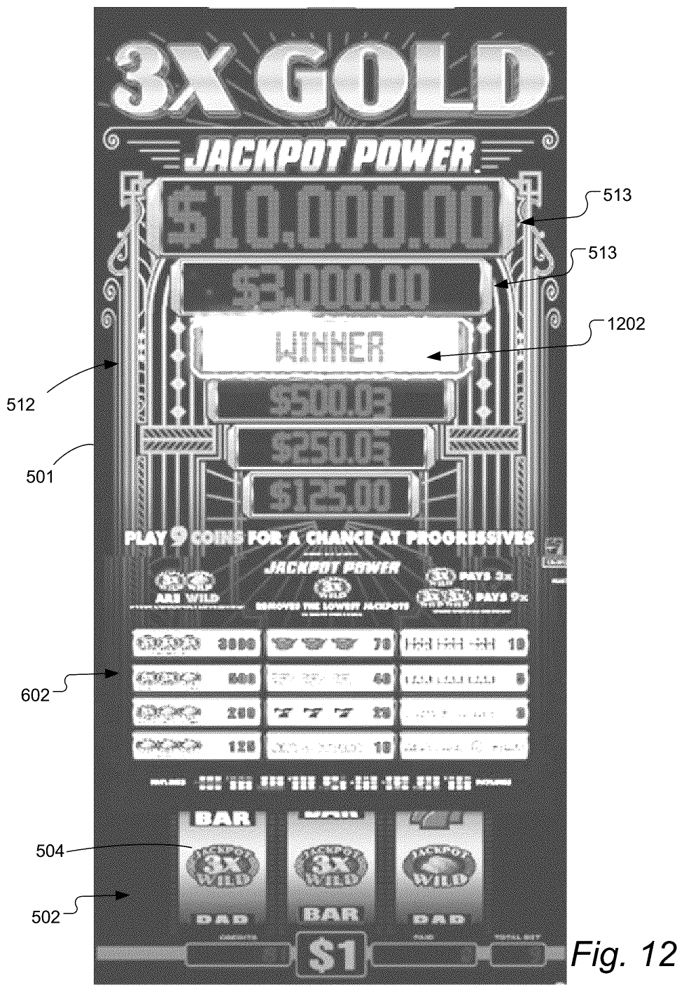

Next, at block 420, the process includes randomly selecting a jackpot prize indicator from the selected set. An example of such selection is shown in the subsequence of FIG. 11 and FIG. 12. Then at block 422, the process includes awarding an associated jackpot prize for the play at the gaming machine. For implementations in which a larger gaming array is used, with more paylines than the single payline employed in the example of FIGS. 6-12, the process may also include evaluating other paylines for winning conditions and bonus features, and awarding results for those according to rules of the game. That is, the process of FIG. 4 focuses on the conduct of a jackpot win round and does not discuss the operation of the remainder of the game.

In some implementations, the winning condition evaluated at block 410 includes the predetermined number of first or second trigger symbols disposed along a winning payline of the game symbol array. In the example implementation of FIGS. 6-12, one jackpot prize indicator is removed responsive to one of the first trigger symbols appearing in the winning condition, and two jackpot prize indicators are removed responsive to two of the first trigger symbols appearing in the winning condition. Four jackpot prize indicators are removed responsive to three of the first trigger symbols appearing in the winning condition. While this implementation employs two trigger symbols in the process of selecting a set of jackpot prize indicators, other implementations may use more than two trigger symbols, or only one trigger symbol. Implementations with only one trigger symbol may select a set of jackpot prize indicators based on the number of trigger symbols, or the location of the trigger symbols, for example.

FIGS. 5 through 12 are now used to describe specific implementations of a process such as that as outlined in FIG. 4. Referring first to FIG. 5, the example reel-type game includes graphics displayed in an area 501 which may be provided by a video display device such as display 104 shown in FIG. 1. The displayed graphics include an initial array of game symbol location made up of an array area 502 including, in the depicted state, six symbol locations 504, and a secondary display area 512 including, in the depicted state, six jackpot prize indicators 513. In the example of FIG. 5 the jackpot prize indicators 513 display jackpot prize values. The value of these prizes in an actual implementation of the game may be fixed values or values which vary in some fashion over time. One or more of the jackpot prizes might be defined as a local or wide area progressive prize which increases substantially continuously based on the value of wagers placed in the gaming system. The prizes may be shown as currency values as indicated in the figures, or as credit values.

In this example, each column of symbol locations 504 is defined by a multiple-symbol reel representation including a first reel 506, a second reel 507, and a third reel 508. In the state of the display shown in FIG. 5, a play in a base portion of the game is in progress. For the purpose of this example, the game symbols are indicated with a letter and number, such as “F8”, “F7”, “M1”, and “M2”.

The illustrated game graphics also include an area 514 for showing credits available for play, an area 515 showing an amount of a win for the most recent play of the game, a multiplier display area 516, a bet level display area 517, and a denomination display area 518. Of these display areas, area 514 and area 515 are shown blank for purposes of this description. It will be appreciated, however, that these areas would show credit values in an actual implementation. As indicated by the arrows in overlaying fourth reel 508 and fifth reel 509, in the depicted state these reels are still spinning to present a game.

FIGS. 6-12 show a sequence of game screen diagrams illustrating different points in time in a game conducted according to the process of FIG. 4 according to some embodiments. The diagrams are arranged largely like that of FIG. 5, and depict a sequence of gaming events in which an example of the jackpot selection process described above is performed. In this implementation, a single payline is defined through array area 502, with a paytable of winning conditions and jackpot feature combinations shown in area 602.

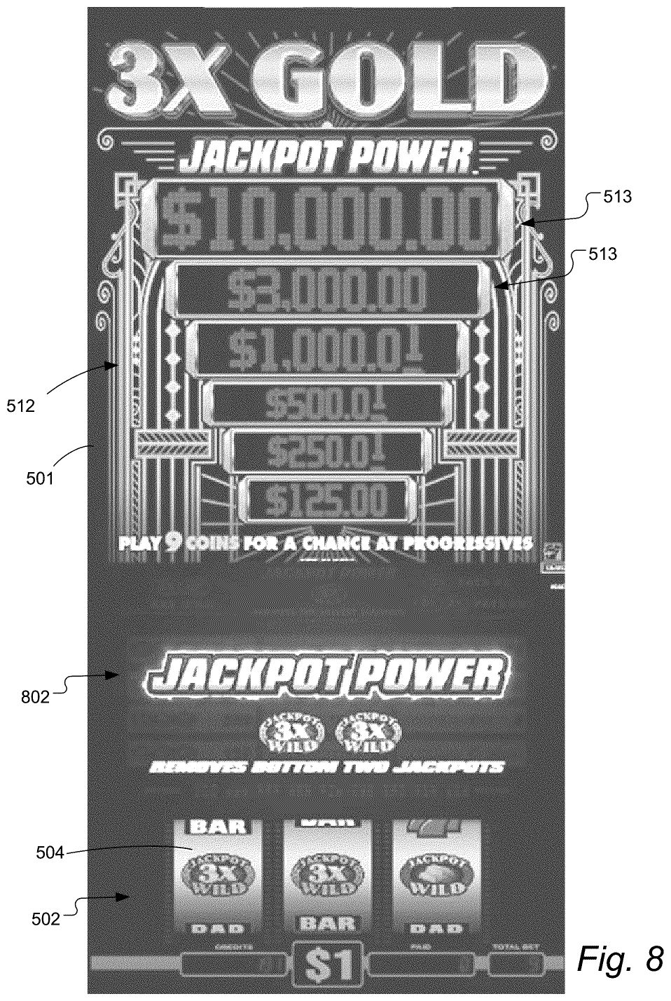

In FIG. 6, the three reels are in motion. FIG. 7 shows array area 502 after the reels have stopped with a winning condition along a single payline 702. FIG. 8 shows the game state after the winning condition has been recognized as triggering the jackpot selection feature, titled “JACKPOT POWER” in this example, and the paytable 602 has been replaced with a notification 802 indicating the JACKPOT POWER feature has been activated. In this example scenario, two of the first trigger symbols 504, labelled “3X Wild”, appear in the winning condition. FIG. 9 shows the beginning of a graphic presentation implementing the jackpot selection process. An animated sequence is displayed directing the player's attention to jackpot prize indicators 513. FIG. 10 shows the game state after the set of jackpot prize indicators for use has been selected. In this example scenario, the two lowest value jackpot prize indicators, labelled 1002, have been removed from the original set of six, as indicated by being greyed out. This selection process leaves a remaining set of the four highest value jackpot prize indicators from which a jackpot prize is to be selected. FIG. 11 shows the game state as a graphic sequence is displayed depicting random selection from the set of jackpot prize indicators. In this example implementation, the random selection is depicted by cycling through the set of jackpot prize indicators with a highlight effect, labelled 1102, until the highlight effect stops to select one of the jackpot prize indicators. Other implementations may, of course, use other graphic sequences to depict the random selection. FIG. 12 shows the game gate after a jackpot prize indicator 1202 has been selected, and a corresponding jackpot is awarded.

The outcome of any game conducted in accordance with the present invention, that is, the prize to be awarded, may be determined in any suitable fashion. In some implementations the various reels may be designed so that they may be randomly stopped and will produce a desired payout and hold over time. Other implementations may obtain a random outcome or an outcome from another game such as “bingo” and then control the various reel spins according to the invention to produce correspond to that outcome.

One way to obtain a random outcome (in terms of prize value) to be displayed through the play described herein uses a random number generator to generate a random number which is used to index a table to lookup an outcome. In such an arrangement, the outcomes are stored in a lookup table which is indexed by the random number to provide suitable distributed, randomly-selected results. The lookup table may have a number of outcome entries, each with an index, a prize amount in credits, and a bonus flag. The outcome entry may have other data fields to control other parts of the game. The bonus flag indicates that the outcome is to be displayed with both the base and bonus portion of game play described above.

As one alternative to a game outcome determined by random number, outcomes be selected from an outcome record pool of predetermined outcome records. In those arrangements, an outcome record may be chosen from a record pool in order to service a play initiated at the gaming machine. Such an outcome record may be chosen from the pool either randomly or from a randomly-organized queue. The chosen record may include a record identifier (rather than an index), a prize amount, and a free-spin bonus flag. An outcome record may have other data fields to control other parts of the game. The free-spin bonus flag indicates that the record outcome will trigger the bonus portion of play. Still other implementations may use a server-hosted bingo game with multiple game play requests participating as bingo cards, the bingo patterns determining prize outcomes.

In some implementations of the invention, one or both of the base portion of play or the bonus portion of play may be controlled by a script which controls the various reel spins to land on game symbols to produce the randomly selected or otherwise obtained outcome for the play. In order to provide a natural feel to the play of the game, numerous scripts may be stored for each potential outcome and the particular script to be used to control the game for a given play may be selected randomly from the scripts available to show the given outcome.

Numerous variations are possible on the example processes described in connection with FIG. 4 and in connection with FIGS. 5-12. For example, the play arrangement shown in FIG. 4 may be used with other bonus play trigger arrangements and is not limited to the process shown in FIG. 4. Another variation may be that the bonus play process described in FIG. 4A and FIGS. 9-12 may not require rearranging the initial array of game symbol locations to produce a bonus array of game symbol locations.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A method of controlling a reel-type gaming machine, the method including:
controlling a display system of the gaming machine to display a game symbol array for a play at the gaming machine including an array area of at least one row and at least three columns in which symbols are shown and evaluated;
controlling the display system of the gaming machine to display a series of jackpot prize indicators in a secondary display area;
during the play at the gaming machine populating game symbol locations in the array area selected from a game symbol set which includes at least a first trigger symbol and a second trigger symbol; and
responsive to a winning condition including a predetermined positive number of trigger symbols comprising zero or more of the first trigger symbols and zero or more of the second trigger symbols, performing a jackpot win round including (i) based on the numbers of first or second trigger symbols in the winning condition, selecting a set of the jackpot prize indicators, and (ii) randomly selecting a jackpot prize indicator from the selected set and awarding an associated jackpot prize for the play at the gaming machine.

2. The method of claim 1 wherein the winning condition includes the predetermined number of first or second trigger symbols disposed along a winning payline of the game symbol array.

3. The method of claim 1 wherein the winning condition includes at least one of the first trigger symbols or the second trigger symbols in each column of the array area.

4. The method of claim 1 wherein selecting a set of the jackpot prize indicators comprises displaying a starting set of jackpot prize indicators and removing one or more of the jackpot prize indicators from the starting set based on the number of first trigger symbols in the winning condition, the one or more removed jackpot prize indicators being those with the lowest value.

5. The method of claim 4 wherein removing one or more of the jackpot prize indicators from the starting set includes displaying a graphic sequence in which the one or more removed jackpot prize indicator is greyed out.

6. The method of claim 4 wherein one jackpot prize indicator is removed responsive to one of the first trigger symbols appearing in the winning condition, and two jackpot prize indicators are removed responsive to two of the first trigger symbols appearing in the winning condition.

7. The method of claim 6 wherein four jackpot prize indicators are removed responsive to three of the first trigger symbols appearing in the winning condition.

8. A gaming machine, the gaming machine including:
(a) a display system;
(b) a player input system;
(c) at least one processor; and
(d) at least one memory device storing instructions executable by the at least one processor to:
control the display system to display a game symbol array for a play at the gaming machine including an array area of at least one row and at least three columns in which symbols are shown and evaluated;
control the display system to display a series of jackpot prize indicators in a secondary display area;
during the play at the gaming machine, populating game symbol locations in the array area selected from a game symbol set which includes at least a first trigger symbol and a second trigger symbol; and
responsive to a winning condition including a predetermined positive number of trigger symbols comprising zero or more of the first trigger symbols and zero or more of the second trigger symbols, perform a jackpot win round including (i) based on the numbers of first or second trigger symbols in the winning condition, selecting a set of the jackpot prize indicators, and (ii) randomly selecting a jackpot prize indicator from the selected set and awarding an associated jackpot prize for the play at the gaming machine.

9. The gaming machine of claim 8 wherein the winning condition includes the predetermined number of first or second trigger symbols disposed along a winning payline of the game symbol array.

10. The gaming machine of claim 8 wherein the winning condition includes at least one of the first trigger symbols or the second trigger symbols in each column of the array area.

11. The gaming machine of claim 8 wherein selecting a set of the jackpot prize indicators comprises displaying a starting set of jackpot prize indicators and removing one or more of the jackpot prize indicators from the starting set based on the number of first trigger symbols in the winning condition, the one or more removed jackpot prize indicators being those with the lowest value.

12. The gaming machine of claim 11 wherein removing one or more of the jackpot prize indicators from the starting set includes displaying a graphic sequence in which the one or more removed jackpot prize indicator is greyed out.

13. The gaming machine of claim 11 wherein one jackpot prize indicator is removed responsive to one of the first trigger symbols appearing in the winning condition, and two jackpot prize indicators are removed responsive to two of the first trigger symbols appearing in the winning condition.

14. The gaming machine of claim 13 wherein four jackpot prize indicators are removed responsive to three of the first trigger symbols appearing in the winning condition.

15. A program product comprising one or more tangible, non-transitory computer readable data storage devices storing program code for a reel-type gaming machine, the program code including:
first program code executable by at least one processor to control a display system of the gaming machine to display a game symbol array for a play at the gaming machine including an array area of at least one row and at least three columns in which symbols are shown and evaluated;
second program code executable by the at least one processor to control the display system to display a series of jackpot prize indicators in a secondary display area;
wherein the first program code is further executable for, during the play at the gaming machine, populating game symbol locations in the array area selected from a game symbol set which includes at least a first trigger symbol and a second trigger symbol; and
third program code executable by the at least one processor for, responsive to a winning condition including a predetermined positive number of trigger symbols comprising zero or more of the first trigger symbols and zero or more of the second trigger symbols, performing a jackpot win round including (i) based on the numbers of first or second trigger symbols in the winning condition, selecting a set of the jackpot prize indicators, and (ii) randomly selecting a jackpot prize indicator from the selected set and awarding an associated jackpot prize for the play at the gaming machine.

16. The program product of claim 15 wherein the winning condition includes the predetermined number of symbols disposed along a winning payline of the game symbol array.

17. The program product of claim 15 wherein the winning condition includes at least one of the first trigger symbols or the second trigger symbols in each column of the array area.

18. The program product of claim 15 wherein selecting a set of the jackpot prize indicators comprises displaying a starting set of jackpot prize indicators and removing one or more of the jackpot prize indicators from the starting set based on the number of first trigger symbols in the winning condition, the one or more removed jackpot prize indicators being those with the lowest value.

19. The program product of claim 18 wherein removing one or more of the jackpot prize indicators from the starting set includes displaying a graphic sequence in which the one or more removed jackpot prize indicator is greyed out.

20. The program product of claim 18 wherein one jackpot prize indicator is removed responsive to one of the first trigger symbols appearing in the winning condition, and two jackpot prize indicators are removed responsive to two of the first trigger symbols appearing in the winning condition.
